(19) United States
(12) Patent Application Publication
(10) Pub. No.: US 2020/0071567 A1
(43) Pub. Date: Mar. 5, 2020

(54) POLISHING COMPOSITION AND POLISHING SYSTEM

(71) Applicant: Fujimi Incorporated, Aichi (JP)

(72) Inventors: Toshio Shinoda, Aichi (JP); Yoshihiro Izawa, Aichi (JP); Daiki Ito, Aichi (JP)

(73) Assignee: Fujimi Incorporated, Aichi (JP)

(21) Appl. No.: 16/557,271

(22) Filed: Aug. 30, 2019

(30) Foreign Application Priority Data
Sep. 4, 2018 (JP) 2018-165032
Jan. 24, 2019 (JP) 2019-010484

(51) Int. Cl. C09G 1/02; C09K 3/14

(52) U.S. Cl. CPC C09G 1/02; C09K 3/1463

(57) ABSTRACT

The polishing composition according to the present invention is used to polish an object to be polished having a silicon oxide film, contains an abrasive grain, a compound having a logarithmic value (Log P) of partition coefficient of 1.0 or more, and a dispersing medium, and has a pH of less than 7.

### BACKGROUND

### 1. Technical Field

The present invention relates to a polishing composition and a polishing system.

### 2. Description of Related Arts

In recent years, as multilayer wiring is fabricated on the surface of a semiconductor substrate, a so-called chemical mechanical polishing (CMP) technique has been utilized to polish and flatten a semiconductor substrate when a device is manufactured. CMP is a method in which the surface of an object to be polished (object to be polished) such as a semiconductor substrate is flattened using a polishing composition (slurry) containing abrasive grains such as silica, alumina, or ceria, an anticorrosive, a surfactant, and the like. The object to be polished (object to be polished) is wiring, plug and the like formed of silicon, polysilicon, a silicon oxide film (silicon oxide), silicon nitride, a metal, and the like.

For example, in Japanese Patent Application Laid-Open No. 2009-88249, a polishing liquid to be used in chemical mechanical polishing in a step of flattening a semiconductor integrated circuit is disclosed which contains a quaternary ammonium cation, an organic acid, inorganic particles, and at least either of a compound represented by a general formula (I) or a polymer containing a structural unit represented by the general formula (I) and has a pH in a range of 1 to 7. In addition, in Japanese Patent Application Laid-Open No. 2009-99819 (corresponding to US Patent Application Laid-Open No. 2009/104778), a polishing composition for chemical mechanical polishing is disclosed which contains a polyglycerin derivative (A) represented by a formula (1), an abrasive material (B), and water.

### SUMMARY

According to the polishing liquids described in Japanese Patent Application Laid-Open No. 2009-88249 and Japanese Patent Application Laid-Open No. 2009-99819 (corresponding to US Patent Application Laid-Open No. 2009/104778), it is possible to suppress the generation of scratches on the surface of a silicon oxide film. However, according to the investigations by the present inventors, it has been found that there is a problem that the suppression of scratching is still insufficient in the techniques described in Japanese Patent Application Laid-Open No. 2009-88249 and Japanese Patent Application Laid-Open No. 2009-99819 (corresponding to US Patent Application Laid-Open No. 2009/104778).

Accordingly, an object of the present invention is to provide a polishing composition with which it is possible to sufficiently decrease scratches on the surface of an object to be polished having a silicon oxide film while maintaining a high polishing speed of the object to be polished having a silicon oxide film.

In order to solve the above problems, the present inventors have intensively conducted studies. As a result, it has been found out that the above problems are solved by a polishing composition to be used to polish an object to be polished having a silicon oxide film, which contains abrasive grains, a compound having a logarithmic value (Log P) of partition coefficient of 1.0 or more, and a dispersing medium and has a pH of less than 7, and the present invention has been thus completed.

### DETAILED DESCRIPTION

Hereinafter, embodiments of the present invention will be described. Incidentally, the present invention is not limited only to the following embodiments. In addition, in the present specification, the operations and the measurements of physical properties and the like are performed under the conditions of room temperature (20° C. or more and 25° C. or less)/relative humidity of 40% RH or more and 50% RH or less unless otherwise stated.

The polishing composition according to an embodiment of the present invention is a polishing composition which is used to polish an object to be polished having a silicon oxide film, contains an abrasive grain, a compound having a logarithmic value (Log P) of partition coefficient of 1.0 or more, and a dispersing medium, and has a pH of less than 7. According to the polishing composition, it is possible to sufficiently decrease scratches on the surface of an object to be polished having a silicon oxide film while maintaining a high polishing speed of the object to be polished having a silicon oxide film.

The details of the reason why the above-mentioned effect is attained by the polishing composition of the present invention are not clear, but the following mechanism is conceivable. However, the following mechanism is a presumption to the utmost, and the scope of the present invention is not limited by this.

By the techniques described in Japanese Patent Application Laid-Open No. 2009-88249 and Japanese Patent Application Laid-Open No. 2009-99819 (corresponding to US Patent Application Laid-Open No. 2009/104778), scratching of the surface of the object to be polished having a silicon oxide film is not sufficiently suppressed and the present inventors have conducted intensive investigations on the cause thereof. In the course of investigations, the present inventors have considered that polishing pad scraps are generated when an object to be polished is polished using a polishing pad, the polishing pad scraps and the abrasive grains are likely to be aggregated by the shearing stress during polishing to form coarse particles, and these coarse particles may cause an increase in scratches on the surface of the object to be polished having a silicon oxide film.

With regard to such a problem, the present inventors have found out that the above problem is solved by a polishing composition which contains abrasive grains, a compound having a logarithmic value (Log P, hereinafter also simply referred to as “Log P”) of partition coefficient of 1.0 or more, and a dispersing medium and has a pH of less than 7. A compound of which Log P is 1.0 or more generally has a hydrophobic moiety and a hydrophilic moiety. The hydrophobic moiety of the compound adheres to the hydrophobic surface of the polishing pad scraps generated during polishing by hydrophobic interaction, and the surface of the polishing pad scraps is hydrophilized. The polishing pad scraps of which the surfaces are hydrophilized are dispersed and stabilized in the dispersing medium (particularly in water), the aggregation thereof with the abrasive grains is suppressed, and thus coarse particles are hardly formed. It is considered that it is thus possible to sufficiently decrease scratches on the surface of an object to be polished having a silicon oxide film while maintaining a high polishing speed of the object to be polished having a silicon oxide film by use of the polishing composition of the present invention in which the formation of coarse particles of polishing pad scraps and abrasive grains is suppressed. Incidentally,

### Log of the “Log P” Means a Common Logarithm.

### <Object to be Polished>

### [Silicon Oxide Film]

The object to be polished according to the present invention has a silicon oxide film. Examples of the silicon oxide film include a TEOS (Tetraethyl Orthosilicate) type silicon oxide film (hereinafter, also simply referred to as “TEOS”) formed using tetraethyl orthosilicate as a precursor, a HDP (High Density Plasma) film, a USG (Undoped Silicate Glass) film, a PSG (Phosphorus Silicate Glass) film, a BPSG (Boron-Phospho Silicate Glass) film, a RTO (Rapid Thermal Oxidation) film and the like.

The object to be polished according to the present invention may contain other materials in addition to silicon oxide. Examples of other materials include silicon nitride, silicon carbonitride (SiCN), polycrystalline silicon (polysilicon), amorphous silicon (amorphous silicon), a metal, SiGe and the like.

### <Polishing Composition>

### [Abrasive Grain]

The kind of the abrasive grains used in the polishing composition of the present invention is not particularly limited, and examples thereof include metal oxides such as silica, alumina, zirconia, and titania. The abrasive grains may be used singly or in combination of two or more kinds thereof. As the abrasive grains, commercially available products may be used or synthetic products may be used.

The kind of the abrasive grains is preferably silica and more preferably colloidal silica. Examples of the method of producing colloidal silica include a sodium silicate method and a sol-gel method. Colloidal silica produced by either production method is suitably used as the abrasive grains of the present invention. However, colloidal silica produced by a sol-gel method is preferable from the viewpoint of decreasing metal impurities. Colloidal silica produced by a sol-gel method is preferable since the content of metal impurities diffusible into the semiconductor and corrosive ions such as chloride ions in this colloidal silica is low. The production of colloidal silica by a sol-gel method can be performed by a conventionally known method. Specifically, colloidal silica can be obtained by performing a hydrolysis/condensation reaction using a hydrolyzable silicon compound (for example, an alkoxysilane or a derivative thereof) as a raw material.

The abrasive grains may be silica (non-modified silica) of which the surface is not modified, but silica (cation-modified silica) having a cationic group is still more preferable, and colloidal silica (cation-modified colloidal silica) having a cationic group is particularly preferable. Silica (colloidal silica) having a cationic group can further improve the polishing speed of an object to be polished having a silicon oxide film. In addition, polishing pad scraps generally have a positive zeta potential under acidic conditions, thus the aggregation of polishing pad scraps with silica (colloidal silica) which has a cationic group and a positive zeta potential is further suppressed, thus coarse particles are less likely to be formed, and scratches on the surface of the object to be polished can be further decreased.

Preferred examples of the colloidal silica (cation-modified colloidal silica) having a cationic group include colloidal silica in which an amino group is immobilized on the surface. Examples of a method of producing such colloidal silica having a cationic group include a method in which a silane coupling agent having an amino group, such as aminoethyltrimethoxysilane, aminopropyltrimethoxysilane, aminoethyltriethoxysilane, aminopropyltriethoxysilane, aminopropyldimethylethoxysilane, aminopropylmethyldiethoxysilane, or aminobutyltriethoxysilane, is immobilized on the surface of abrasive grains as described in Japanese Patent Application No. 2005-162533. This makes it possible to obtain colloidal silica in which an amino group is immobilized on the surface.

The shape of the abrasive grains is not particularly limited and may be a spherical shape or a non-spherical shape. Specific examples of non-spherical shapes include various shapes such as polygonal columns such as a triangular column and a quadrangular column, a cylindrical shape, a bale shape in which the central portion of a cylinder is bulged more than the end portion, a donut shape in which the central portion of a disc penetrates, a tabular shape, a so-called cocoon shape having a constriction at the central portion, a so-called associated spherical shape in which a plurality of particles are integrated, a so-called kompeito shape having a plurality of bulges on the surface, and a rugby ball shape, and the shape is not particularly limited.

The size of the abrasive grains is not particularly limited, but the lower limit of the average primary particle size of the abrasive grains is preferably 5 nm or more, more preferably 7 nm or more, and still more preferably 10 nm or more. In addition, the upper limit of the average primary particle size of the abrasive grains in the polishing composition of the present invention is preferably 120 nm or less, more preferably 80 nm or less, and still more preferably 50 nm or less. When the size is in such a range, it is possible to suppress the generation of defects such as scratches on the surface of the object to be polished after being polished using the polishing composition. In other words, the average primary particle size of the abrasive grains is preferably 5 nm or more and 120 nm or less, more preferably 7 nm or more and 80 nm or less, and still more preferably 10 nm or more and 50 nm or less. Incidentally, the average primary particle size of the abrasive grains is calculated based on, for example, the specific surface area of the abrasive grains measured by a BET method.

The lower limit of the average secondary particle size of the abrasive grains in the polishing composition of the present invention is preferably 10 nm or more, more preferably 20 nm or more, and still more preferably 30 nm or more. In addition, the upper limit of the average secondary particle size of the abrasive grains in the polishing composition of the present invention is preferably 250 nm or less, more preferably 200 nm or less, and still more preferably 150 nm or less. When the size is in such a range, it is possible to suppress the generation of defects such as scratches on the surface of the object to be polished after being polished using the polishing composition. In other words, the average secondary particle size of the abrasive grains is preferably 10 nm or more and 250 nm or less, more preferably 20 nm or more and 200 nm or less, and still more preferably 30 nm or more and 150 nm or less. Incidentally, the average secondary particle size of the abrasive grains can be measured, for example, by a dynamic light scattering method typified by a laser diffraction scattering method.

The average degree of association of the abrasive grains is preferably 5.0 or less, more preferably 3.0 or less, and still more preferably 2.5 or less. As the average degree of association of the abrasive grains decreases, the generation of defects on the surface of the object to be polished can be further diminished. In addition, the average degree of association of the abrasive grains is preferably 1.0 or more and more preferably 1.2 or more. As the average degree of association of the abrasive grains increases, there is an advantage that the polishing speed by the polishing composition is improved. Incidentally, the average degree of association of the abrasive grains can be attained by dividing the value of the average secondary particle size of the abrasive grains by the value of the average primary particle size thereof.

The upper limit of the aspect ratio of the abrasive grains is not particularly limited but is preferably less than 2.0, more preferably 1.8 or less, and still more preferably 1.5 or less. When the aspect ratio is in such a range, defects on the surface of the object to be polished can be further decreased. Incidentally, the aspect ratio is an average of the values attained by taking the smallest rectangle circumscribing the image of abrasive grains taken using a scanning electron microscope and dividing the length of the long side of the rectangle by the length of the short side of the same rectangle and can be determined using general image analysis software. The lower limit of the aspect ratio of the abrasive grains is not particularly limited but is preferably 1.0 or more.

In the particle size distribution of abrasive grains determined by a laser diffraction scattering method, the lower limit of the ratio D90/D10 of the particle diameter (D90) when the particle weight integrated from the fine particle side reaches 90% of the entire particle weight to the particle diameter (D10) when the particle weight integrated from the fine particle side reaches 10% of the entire particle weight of all particles is not particularly limited but is preferably 1.1 or more, more preferably 1.2 or more, and still more preferably 1.3 or more. In addition, in the particle size distribution of the abrasive grains in the polishing composition determined by a laser diffraction scattering method, the upper limit of the ratio D90/D10 of the particle diameter (D90) when the particle weight integrated from the fine particle side reaches 90% of the entire particle weight to the particle diameter (D10) when the particle weight integrated from the fine particle side reaches 10% of the entire particle weight of all particles is not particularly limited but is preferably 2.04 or less. When the aspect ratio is in such a range, defects on the surface of the object to be polished can be further decreased.

The size (average primary particle size, average secondary particle size, aspect ratio, D90/D10 and the like) of the abrasive grains can be appropriately controlled by the selection of the method of producing the abrasive grains and the like.

The lower limit of the content (concentration) of the abrasive grains in the polishing composition of the present invention is preferably 0.01% by mass or more, more preferably 0.05% by mass or more, and still more preferably 0.1% by mass or more. In addition, the upper limit of the content of the abrasive grains in the polishing composition of the present invention is preferably 20% by mass or less, more preferably 10% by mass or less, still more preferably 5% by mass or less, and yet still more preferably 3% by mass or less. When the upper limit is as described above, it is possible to further suppress the generation of surface defects on the surface of the object to be polished after being polished using the polishing composition. Incidentally, in a case in which the polishing composition contains two or more kinds of abrasive grains, the content of the abrasive grains is intended to be the total amount of these.

### [Compound Having Logarithmic Value (Log P) of Partition Coefficient of 1.0 or More (Scratch Decreasing Agent)]

The polishing composition of the present invention contains a compound (hereinafter also referred to as “scratch decreasing agent”) having a logarithmic value (Log P, hereinafter also simply referred to as “Log P”) of partition coefficient of 1.0 or more. The scratch decreasing agent adheres to the surface of the hydrophobic polishing pad scraps generated during polishing and hydrophilizes the surface of the polishing pad scraps. By this, the formation of coarse particles of polishing pad scraps and abrasive grains is suppressed and it is possible to sufficiently decrease scratches on the surface of an object to be polished having a silicon oxide film while maintaining a high polishing speed of the object to be polished having a silicon oxide film.

Here, “Log P” is a value indicating the affinity of an organic compound for water and 1-octanol. The partition coefficient P of 1-octanol/water is the ratio of the equilibrium concentrations of a compound in the respective solvents at the partition equilibrium when a small amount of the compound as a solute is dissolved in a solvent of two liquid phases of 1-octanol and water and is denoted as the log thereof Log P with respect to the base 10. In other words, “Log P” is a logarithmic value of the partition coefficient P of 1-octanol/water and is known as a parameter indicating the hydrophilicity/hydrophobicity of a molecule.

Incidentally, in the present specification, the logarithmic value (Log P) of partition coefficient is calculated from the structure of a chemical substance using ACD/PhyChem Suite (ACD/Labs).

The Log P of the scratch decreasing agent used in the present invention is 1.0 or more. In a case in which Log P is less than 1.0, the adsorption of the scratch decreasing agent to polishing pad scraps by the hydrophobic interaction hardly occurs and the formation of coarse particles cannot be suppressed.

Specific examples of the scratch decreasing agent having a Log P of 1.0 or more are listed below. Incidentally, the numerical value in parentheses written after the compound name is the values of Log P. Isobutyric acid (1.0), 2-aminophenol (1.0), dipropylene glycol dimethyl ether (1.02), 2,5-dihydroxyterephthalic acid (1.1), 2-phenoxyethanol (1.1), dipropylene glycol monobutyl ether (1.13), 3,5-dimethylthiazole (1.18), 2-pentanol (1.19), propylene glycol monobutyl ether (1.19), diethylene glycol monobutyl ether (1.19), benzotriazole (1.22), 2-pentyl glyceryl ether (1.25), N-4-hydroxyphenylglycine (1.3), 1,2-octanediol (1.3), isovaleric acid (1.3), sorbitan monocaprylate (1.33), tripropylene glycol monobutyl ether (1.34), ethyl gallate (1.4), 1-pentanol (1.4), tripropylene glycol dimethyl ether (1.46), 2-hydroxyethyl salicylate (1.5), 4-hydroxybenzenesulfonic acid (1.5), transferruric acid (1.5), 2,4-dihydroxybenzoic acid (1.5), 1,2-heptanediol (1.5), 1-phenoxy-2-propanol (1.52), 1,2-octanediol (1.54), ethylene glycol mono-n-hexyl ether (1.57), p-coumaric acid (1.6), 3-hydroxybenzoic acid (1.6), 2,5-dihydroxybenzoic acid (1.6), 2,6-dihydroxybenzoic acid (1.6), ethylene glycol monohexyl ether (1.7), diethylene glycol monohexyl ether (1.7), propylene glycol dipropionate (1.76), ethylene glycol monobutyl ether acetate (1.79), diethylene glycol di-n-butyl ether (1.92), 2-ethylhexyl glyceryl ether (2.0), diisopropyl adipate (2.04), 1-octyl glyceryl ether (2.1), salicylic acid (2.1), 3-chloro-4-hydroxybenzoic acid (2.1), 2,4-dimethylthiazole (2.15), 5-chlorosalicylic acid (2.3), ethylene glycol mono(2-ethylhexyl) ether (2.46), 1-phenyl-5-mercaptotetrazole (2.56), 3,5-dichloro-4-hydroxybenzoic acid (2.8), dimethyllaurylamine oxide (3.09), sucrose laurate (3.18), 1,3-diphenylguanidine (3.34), sorbitan monolaurate (3.37), isopropyl myristate (4.42), tetradecanal (4.67), sodium laurate (4.77), myristic acid (4.94), sucrose palmitate (5.22), octyl salicylate (5.4), propylene glycol dicaprylate (5.47), 1-methylundecane (5.51), sucrose oleate (5.85), ricinoleic acid (5.9), stearic acid (6.61), oleic acid diethanolamide (6.68), 2-hexyl-1-decanol (6.8), oleic acid (7.0), triethylhexanoin (7.05), sodium oleate (7.42), phytol (8.0), isooctyl palmitate (8.86), caprylic/capric triglyceride (9.25), and tocopherol acetate (10.61).

The scratch decreasing agent may be used singly or in combination of two or more kinds thereof. In addition, as the scratch decreasing agent, commercially available products may be used or synthetic products may be used.

The lower limit of Log P of the scratch decreasing agent is preferably 1.1 or more, more preferably 1.2 or more, still more preferably 1.3 or more, and particularly preferably more than 1.3 from the viewpoint of further decreasing scratches. In addition, the upper limit of Log P of the scratch decreasing agent is not particularly limited but is preferably 7.0 or less, more preferably 5.0 or less, and still more preferably 4.0 or less from the viewpoint of further enhancing the dispersion stability of the polishing pad scraps.

In addition, the scratch decreasing agent is preferably a surfactant. If the scratch decreasing agent is a surfactant, there is an advantage that a surface activating effect is attained. Examples of such a scratch decreasing agent which is a surfactant include sorbitan monocaprylate (1.33), dimethyllaurylamine oxide (3.09), sucrose laurate (3.18), sorbitan monolaurate (3.37), sodium laurate (4.77), sucrose palmitate (5.22), sucrose oleate (5.85), oleic acid diethanolamide (6.68), sodium oleate (7.42), isooctyl palmitate (8.86) and the like.

Furthermore, it is preferable that the scratch decreasing agent does not have a sulfur atom. The scratch decreasing agent having a sulfur atom is highly hydrophobic, and the dispersion stability thereof in water may be diminished. In addition, under a condition having a pH of less than 7, the polishing pad scraps are positively charged, and the hydrophilic moiety (the oxo acid moiety mainly having a sulfur atom) of the scratch decreasing agent having a sulfur atom is negatively charged. For this reason, not the hydrophobic moiety of the scratch decreasing agent but the hydrophilic moiety (the oxo acid moiety mainly having a sulfur atom) having a sulfur atom of the scratch decreasing agent is electrostatically adsorbed to the polishing pad scraps and the effect of hydrophilizing the polishing pad scraps may be diminished. On the other hand, a scratch decreasing agent which has a functional group such as a hydroxyl group or a carboxylic acid group and does not have a sulfur atom exhibits high dispersion stability in water and the hydrophilic moiety (hydroxyl group or carboxylic acid group) of the scratch decreasing agent which does not have a sulfur atom has a lower degree of ionization than the hydrophilic moiety (oxo acid moiety) having a sulfur atom. Hence, the electric charge of the hydrophilic moiety of the scratch decreasing agent which does not have a sulfur atom is lower than the electric charge of the hydrophilic moiety (oxo acid moiety) having a sulfur atom. For this reason, the degree to which the hydrophilic moiety of the scratch decreasing agent which does not have a sulfur atom is electrostatically adsorbed to the surface of the polishing pad scraps is lower than that of the hydrophilic moiety having a sulfur atom, and the degree of adsorption of the hydrophilic moiety of the scratch decreasing agent which does not have a sulfur atom by the hydrophobic interaction with the polishing pad scraps is high. Hence, the scratch decreasing agent which does not have a sulfur atom can further enhance the effect of hydrophilizing the polishing pad scraps, and the effect of the present invention is further improved. It is more preferable that the scratch decreasing agent does not have both a sulfur atom and a nitrogen atom from the same viewpoint.

The content (concentration) of the scratch decreasing agent is not particularly limited but is preferably 1 ppm by mass or more, more preferably 10 ppm by mass or more, and still more preferably 30 ppm by mass or more with respect to the entire mass of the polishing composition. In addition, the upper limit of the content (concentration) of the scratch decreasing agent is preferably 10000 ppm by mass or less, more preferably 5000 ppm by mass or less, and still more preferably 3000 ppm by mass or less with respect to the entire mass of the polishing composition. In other words, the content (concentration) of the scratch decreasing agent is preferably 1 ppm by mass or more and 10000 ppm by mass or less, more preferably 10 ppm by mass or more and 5000 ppm by mass or less, and still more preferably 30 ppm by mass or more and 3000 ppm by mass or less with respect to the entire mass of the polishing composition. When the content (concentration) is in such a range, the effect of the present invention that scratches decrease while a high polishing speed is maintained is efficiently attained. Incidentally, in a case in which the polishing composition contains two or more kinds of scratch decreasing agents, the content of the scratch decreasing agent is intended to be the total amount of these.

### [Dispersing Medium]

In the polishing composition of the present invention, a dispersing medium is used in order to disperse the respective components constituting the polishing composition. Examples of the dispersing medium include an organic solvent and water, and water is preferable among these.

Water which does not contain impurities as possible is preferable as the dispersing medium from the viewpoint of suppressing the contamination of the object to be polished and the inhibition of the action of other components. As such water, for example, water having a total content of transition metal ions of 100 ppb by mass or less is preferable. Here, the purity of water can be increased by, for example, operations such as removal of impurity ions using an ion exchange resin, removal of foreign matters using a filter, and distillation. Specifically, as water, it is preferable to use, for example, deionized water (ion-exchanged water), pure water, ultrapure water, distilled water, and the like. Usually, preferably 90% by volume or more of the dispersing medium contained in the polishing composition is water, more preferably 95% by volume or more of the dispersing medium is water, and still more preferably 99% by volume or more of the dispersing medium is water, and particularly preferably 100% by volume of the dispersing medium is water.

### [pH of Polishing Composition]

The pH of the polishing composition of the present invention is less than 7. When the pH is 7 or more, the effect of decreasing scratches on the surface of the object to be polished having a silicon oxide film is not attained. In addition, the polishing rate of the object to be polished having a silicon oxide film also decreases. The pH may be 6.5 or less, 6 or less, 5.5 or less, 5.0 or less, less than 5.0, 4.0 or less, or 3.5 or less. In addition, the lower limit of the pH may be 1 or more, 1.5 or more, 2 or more, 2.5 or more, 3 or more, or 3.5 or more.

Incidentally, the pH of the polishing composition is preferably 1.5 or more and 3.5 or less in the case of using silica (non-modified silica) of which the surface is not modified as abrasive grains. In addition, the pH of the polishing composition is preferably 3.5 or more and 5.5 or less in the case of using cation-modified silica as abrasive grains.

Incidentally, the pH of the polishing composition can be measured by the method described in Examples.

### (pH Adjusting Agent and pH Buffer Agent)

The polishing composition according to the present invention may further contain a pH adjusting agent for the purpose of adjusting the pH to the above range.

As the pH adjusting agent, known acids, bases, or salts thereof can be used. Specific examples of the acid which can be used as a pH adjusting agent include inorganic acids such as hydrochloric acid, sulfuric acid, nitric acid, hydrofluoric acid, boric acid, carbonic acid, hypophosphorous acid, phosphorous acid, and phosphoric acid and organic acids such as formic acid, acetic acid, propionic acid, butyric acid, valeric acid, 2-methylbutyric acid, n-hexanoic acid, 3,3-dimethylbutyric acid, 2-ethylbutyric acid, 4-methylpentanoic acid, n-heptanoic acid, 2-methylhexanoic acid, n-octanoic acid, 2-ethylhexanoic acid, benzoic acid, glycolic acid, salicylic acid, glyceric acid, oxalic acid, malonic acid, succinic acid, glutaric acid, adipic acid, pimelic acid, maleic acid, phthalic acid, malic acid, tartaric acid, citric acid, lactic acid, diglycolic acid, 2-furancarboxylic acid, 2,5-furandicarboxylic acid, 3-furancarboxylic acid, 2-tetrahydrofurancarboxylic acid, methoxyacetic acid, methoxyphenylacetic acid, phenoxyacetic acid, and etidronic acid (1-hydroxyethane-1,1-diphosphonic acid, HEDP).

Examples of the base which can be used as a pH adjusting agent include amines such as aliphatic amines such as ethanolamine and 2-amino-2-ethyl-1,3-propanediol, and aromatic amines, organic bases such as quaternary ammonium hydroxide, hydroxides of alkali metals such as potassium hydroxide, hydroxides of alkaline earth metals, tetramethyl ammonium hydroxide, ammonia, and the like.

The pH adjusting agent may be used singly or in combination of two or more kinds thereof.

In addition, in combination with the above-mentioned acids, ammonium salts and alkali metal salts such as a sodium salt and a potassium salt of the above-mentioned acids may be used as a pH buffer agent.

The amounts of the pH adjusting agent and pH buffer agent added are not particularly limited and may be appropriately adjusted so that the pH of the polishing composition is in a desired range.

### [Other Additives]

The polishing composition of the present invention may further contain known additives such as a chelating agent, a thickener, an oxidizing agent, a dispersing agent, a surface protecting agent, a wetting agent, a surfactant having a Log P of less than 1.0, an anticorrosive, an antiseptic agent, and an antifungal agent in a range in which the effects of the present invention are not impaired. The content of the additives may be appropriately set depending on the purpose of the addition thereof.

It is preferable that the polishing composition of the present invention does not substantially contain an oxidizing agent. Specific examples of the oxidizing agent referred to herein include hydrogen peroxide (H₂O₂), sodium persulfate, ammonium persulfate, sodium dichloroisocyanurate and the like. Incidentally, “the polishing composition does not substantially contain an oxidizing agent” means that at least an oxidizing agent is not intentionally contained. Hence, a polishing composition unavoidably containing a trace amount of oxidizing agent derived from a raw material, a production method and the like may be included in the concept of a polishing composition which does not substantially contain an oxidizing agent referred to herein. For example, the molar concentration of the oxidizing agent in the polishing composition is 0.0005 mol/L or less, preferably 0.0001 mol/L or less, more preferably 0.00001 mol/L or less, and particularly preferably 0.000001 mol/L or less.

### <Method of Producing Polishing Composition>

The method of producing a polishing composition of the present invention is not particularly limited, and for example, a polishing composition can be obtained by stirring and mixing abrasive grains, a compound having a Log P of 1.0 or more, and other additives if necessary in a dispersing medium. The details of the respective components are as described above. Hence, the present invention provides a method of producing a polishing composition which is used to polish an object to be polished having a silicon oxide film and has a pH of less than 7.0, which includes mixing abrasive grains, a compound having a Log P of 1.0 or more, and a dispersing medium.

The temperature at which the respective components are mixed is not particularly limited but is preferably 10° C. or more and 40° C. or less, and heating may be performed to increase the rate of dissolution. In addition, the mixing time is also not particularly limited as long as uniform mixing is performed.

### <Polishing Method and Method of Manufacturing Semiconductor Substrate>

As described above, the polishing composition of the present invention is suitably used in the polishing of an object to be polished having a silicon oxide film. Hence, the present invention provides a polishing method including preparing an object to be polished having a silicon oxide film and polishing the object to be polished using the polishing composition of the present invention. In addition, the present invention provides a method of manufacturing a semiconductor substrate, which includes polishing a semiconductor substrate having a silicon oxide film by the polishing method described above.

As the polishing apparatus, it is possible to use a general polishing apparatus to which a holder for holding a substrate or the like having an object to be polished, a motor capable of changing the number of revolutions and the like are attached and has a polishing platen to which a polishing pad (polishing cloth) can be attached.

As the polishing pad, a general non-woven fabric, polyurethane, a porous fluororesin and the like can be used without particular limitation. The polishing pad is preferably subjected to grooving so that the polishing liquid is accumulated in the groove.

With regard to the polishing conditions, for example, the rotational speed of the polishing platen is preferably 10 rpm (0.17 s⁻¹) or more and 500 rpm (8.3 s⁻¹) or less. The pressure (polishing pressure) applied to the substrate having an object to be polished is preferably 0.5 psi (3.4 kPa) or more and 10 psi (68.9 kPa) or less. The method of supplying the polishing composition to the polishing pad is not particularly limited, and, for example, a method in which the polishing composition is continuously supplied to the polishing pad using a pump or the like is employed. There is no limitation on this amount supplied, but it is preferable that the surface of the polishing pad is covered with the polishing composition of the present invention at all times.

After completion of polishing, the substrate is washed in running water, and the water droplets attached to the substrate are shaken off and the substrate is dried using a spin dryer and the like, whereby a substrate having a metal-containing layer is obtained.

The polishing composition of the present invention may be a one-component type or a multi-component type including a two-component type. In addition, the polishing composition of the present invention may be prepared by diluting a stock solution of a polishing composition with a diluent such as water, for example, 10-times or more.

### <Polishing System>

The present invention provides a polishing system including an object to be polished having a silicon oxide film, a polishing pad, and a polishing composition, in which the polishing composition contains abrasive grains, a compound having a Log P of 1.0 or more, and a dispersing medium and the surface of the object to be polished is brought into contact with the polishing pad and the polishing composition.

The object to be polished and polishing composition which are applied to the polishing system of the present invention are the same as those described above, and thus the description thereof is omitted here.

The polishing pad used in the polishing system of the present invention is not particularly limited, and, for example, a foamed polyurethane type, a non-woven fabric type, a suede type, one containing abrasive grains, one not containing abrasive grains and the like can be used.

The polishing system of the present invention may be one in which both sides of the object to be polished are brought into contact with the polishing pad and the polishing composition to simultaneously polish both sides of the object to be polished or may be one in which only one side of the object to be polished is brought into contact with the polishing pad and the polishing composition to polish only one side of the object to be polished.

In the polishing system of the present invention, a working slurry containing the above-described polishing composition is prepared. Subsequently, the polishing composition is supplied to the object to be polished and the object to be polished is polished by a conventional method. For example, the object to be polished is set in a general polishing apparatus, and the polishing composition is supplied to the surface (surface to be polished) of the object to be polished through the polishing pad of the polishing apparatus. Typically, the polishing pad is pressed against the surface of the object to be polished and both of these are relatively moved (for example, rotationally moved) while continuously supplying the polishing composition. Polishing of the object to be polished is completed by passing through this polishing step.

With regard to the polishing conditions, for example, the rotational speed of the polishing platen is preferably 10 rpm (0.17 s⁻¹) or more and 500 rpm (8.3 s⁻¹) or less. The pressure (polishing pressure) applied to the substrate having an object to be polished is preferably 0.5 psi (3.4 kPa) or more and 10 psi (68.9 kPa) or less. The method of supplying the polishing composition to the polishing pad is not particularly limited, and, for example, a method in which the polishing composition is continuously supplied to the polishing pad using a pump or the like is employed. There is no limitation on this amount supplied, but it is preferable that the surface of the polishing pad is covered with the polishing composition of the present invention at all times.

While embodiments of the present invention have been described in detail, it should be understood that this is illustrative and exemplary, and not limiting, and the scope of the present invention should be interpreted by the appended claims.

The present invention includes the following aspects and embodiments.

1. A polishing composition to be used to polish an object to be polished having a silicon oxide film,

the polishing composition containing an abrasive grain, a compound having a logarithmic value (Log P) of partition coefficient of 1.0 or more, and a dispersing medium, in which

a pH of the polishing composition is less than 7.0.

2. The polishing composition according to 1, in which a logarithmic value (Log P) of a partition coefficient of the compound is 7.0 or less.

3. The polishing composition according to 1 or 2, in which the compound is a surfactant.

4. The polishing composition according to any one of 1 to 3, in which the polishing composition does not substantially contain an oxidizing agent.

5. The polishing composition according to any one of 1 to 4, in which the compound does not have a sulfur atom.

6. The polishing composition according to any one of 1 to 5, in which the abrasive grain is non-modified silica.

7. The polishing composition according to 6, in which the pH is 1.5 or more and 3.5 or less.

8. The polishing composition according to any one of 1 to 5, in which the abrasive grain is cation-modified silica.

9. The polishing composition according to 8, in which the pH is 3.5 or more and 5.5 or less.

10. A method of producing a polishing composition which is used to polish an object to be polished having a silicon oxide film and has a pH of less than 7.0, the method including

mixing an abrasive grain, a compound having a logarithmic value (Log P) of partition coefficient of 1.0 or more, and a dispersing medium.

11. A polishing method including:

preparing an object to be polished having a silicon oxide film; and

polishing a surface of the object to be polished using the polishing composition according to any one of 1 to 9.

12. A method of manufacturing a semiconductor substrate, the method including polishing a semiconductor substrate having a silicon oxide film by the polishing method according to 11.

13. A polishing system including an object to be polished having a silicon oxide film, a polishing pad, and a polishing composition, in which

the polishing composition contains an abrasive grain, a compound having a logarithmic value (Log P) of partition coefficient of 1.0 or more, and a dispersing medium and has a pH of less than 7.0, and

a surface of the object to be polished is brought into contact with the polishing pad and the polishing composition.

### EXAMPLES

The present invention will be described in more detail with reference to the following Examples and Comparative Examples. However, the technical scope of the present invention is not limited only to the following Examples. Incidentally, “%” and “parts” respectively mean “% by mass” and “parts by mass” unless otherwise stated. In addition, in the following Examples, the operations are performed under the conditions of room temperature (20° C. or more and 25° C. or less)/relative humidity of 40% RH or more and 50% RH or less unless otherwise stated.

### <Preparation of Polishing Composition>

### Example 1

Cation-modified colloidal silica (average primary particle size: 31 nm, average secondary particle size: 62 nm, average degree of association: 2.0) as abrasive grains was added to water so as to be at a concentration of 1.5% by mass with respect to 100% by mass of the entire mass of the polishing composition. Furthermore, acetic acid, ammonium acetate, and oleic acid diethanolamide were added thereto so as to be at a concentration of 0.15 g/L, a concentration of 0.06 g/L, and a concentration of 100 ppm by mass, respectively. Thereafter, the mixture was stirred and mixed at room temperature (25° C.) for 30 minutes, thereby preparing a polishing composition. The pH of the polishing composition obtained was 4.5.

The average primary particle size of the abrasive grains was calculated from the specific surface area of the abrasive grains measured by the BET method using “Flow Sorb II 2300” manufactured by Micromeritics Instrument Corporation, and the density of the abrasive grains. In addition, the average secondary particle size of the abrasive grains was measured using a dynamic light scattering particle diameter and particle size distribution apparatus UPA-UTI151 manufactured by Nikkiso Co., Ltd. Furthermore, the pH of the polishing composition (liquid temperature: 25° C.) was confirmed using a pH meter (model: LAQUA manufactured by HORIBA, Ltd.).

### Examples 2 to 4 and Comparative Examples 1 to 8

Each polishing composition was prepared in the same manner as in Example 1 except that the kind of the scratch decreasing agent and the kind of the pH adjusting agent were changed as presented in the following Table 1.

### [Evaluation 1]

A 200 mm BPSG substrate (manufactured by Advanced Materials Technology, INC.) was prepared as an object to be polished. The BPSG substrate was polished under the following polishing conditions using the respective polishing compositions of Examples 1 to 4 and Comparative Examples 1 to 8 obtained above.

### (Polishing Conditions)

Mirra (manufactured by Applied Materials, Inc.) was used as a polishing machine, IC1000 (manufactured by Rohm and Haas Company) was used as a polishing pad, and A165 (manufactured by 3M Company) was used as a conditioner of the polishing pad, respectively. The polishing was performed for a polishing time of 60 seconds under the conditions of a polishing pressure of 4.0 psi (27.59 kPa), the number of revolutions of platen of 123 rpm, the number of revolutions of head of 117 rpm, and a supply rate of polishing composition of 130 ml/min. The pad conditioning with a conditioner was performed in-situ at the number of revolutions of 120 rpm and a pressure of 5 lbf (22.24 N) during the polishing.

### <Number of Scratches>

With regard to the number of scratches on the surface of the object to be polished, the number of scratches was measured by measuring the coordinates of the entire surface of the wafer (however, excluding the outer circumference by 2 mm) using a wafer inspection apparatus “Surfscan (registered trademark) SP2” manufactured by KLA-Tencor Corporation and completely observing the measured coordinates using Review-SEM (RS-6000 manufactured by Hitachi High-Technologies Corporation).

### <Polishing Rate>

The polishing rate (Removal Rate; RR, polishing speed) was calculated by the following equation. Incidentally, 1 Å=0.1 nm.

$$Polishing rate [ Å / min ] = \frac{\begin{matrix}Film thickness before polishing [ Å ] - \\ Film thickness after polishing [ Å ]\end{matrix}}{Polishing time [ min ]} \qquad [ Math . 1 ]$$

The polishing rate was evaluated by determining the film thickness using a light interference type film thickness measurement apparatus (manufactured by KLA-Tencor Corporation, model: ASET-f5x) and dividing the difference in film thickness before and after polishing by the polishing time.

The evaluation results on the number of scratches and the polishing rate are presented in the following Table 1.

TABLE 1

| | Abrasive | | | | | | | | | BPSG | BPSG |
|---|---|---|---|---|---|---|---|---|---|---|---|
| | grain | pH adjusting | | | | Scratch decreasing agent | | | | film | film |
| | Content | agent | | pH buffer agent | | | Content | | Polishing | Number of | Polishing |
| | (% by | | Content | | Content | | (ppm by | Log | composition | scratches | rate |
| | mass) | Kind | (g/L) | Kind | (g/L) | Kind | mass) | P | pH | (pieces) | (Å/min) |
| Example 1 | 1.5 | Acetic | 0.15 | Ammonium | 0.06 | Oleic acid | 100 | 6.68 | 4.5 | 56 | 5651 |
| | | acid | | acetate | | diethanolamide | | | | | |
| Example 2 | 1.5 | Acetic | 0.15 | Ammonium | 0.06 | Dimethyllaurylamine | 100 | 3.09 | 4.5 | 53 | 5421 |
| | | acid | | acetate | | oxide | | | | | |
| Example 3 | 1.5 | Acetic | 0.15 | Ammonium | 0.06 | Sucrose laurate | 100 | 3.18 | 4.5 | 40 | 5243 |
| | | acid | | acetate | | | | | | | |
| Example 4 | 1.5 | Acetic | 0.15 | Ammonium | 0.06 | Sorbitan | 100 | 1.33 | 4.5 | 41 | 5864 |
| | | acid | | acetate | | monocaprylate | | | | | |
| Comparative | 1.5 | Acetic | 0.15 | Ammonium | 0.06 | Ethanol | 100 | −0.18 | 4.5 | 102 | 5564 |
| Example 1 | | acid | | acetate | | | | | | | |
| Comparative | 1.5 | Acetic | 0.15 | Ammonium | 0.06 | Sucrose | 100 | −4.49 | 4.5 | 198 | 5540 |
| Example 2 | | acid | | acetate | | | | | | | |
| Comparative | 1.5 | Acetic | 0.15 | Ammonium | 0.06 | Lactose | 100 | −3.39 | 4.5 | 185 | 5461 |
| Example 3 | | acid | | acetate | | | | | | | |
| Comparative | 1.5 | Acetic | 0.15 | Ammonium | 0.06 | Xylitol | 100 | −2.65 | 4.5 | 146 | 5516 |
| Example 4 | | acid | | acetate | | | | | | | |
| Comparative | 1.5 | Acetic | 0.15 | Ammonium | 0.06 | Glycerin | 100 | −1.85 | 4.5 | 168 | 5313 |
| Example 5 | | acid | | acetate | | | | | | | |
| Comparative | 1.5 | Acetic | 0.15 | Ammonium | 0.06 | D-sorbitol | 100 | −3.26 | 4.5 | 126 | 5591 |
| Example 6 | | acid | | acetate | | | | | | | |
| Comparative | 1.5 | Ammonia | 5.87 | — | — | — | — | — | 10 | 176 | 89 |
| Example 7 | | | | | | | | | | | |
| Comparative | 1.5 | Ammonia | 5.91 | — | — | Dimethyllaurylamine | 100 | 3.09 | 10 | 61 | 94 |
| Example 8 | | | | | | oxide | | | | | |

As apparent from Table 1 above, it has been found that the object to be polished having a BPSG film can be polished at a high polishing speed and scratches on the surface of the object to be polished having a BPSG film can be sufficiently decreased in the case of using the polishing compositions of Examples containing a scratch decreasing agent having a Log P of 1.0 or more as compared to the polishing compositions of Comparative Examples 1 to 8. On the other hand, it has been found that a decrease in scratches on the surface of the object to be polished having a BPSG film is insufficient in the case of using the polishing compositions of Comparative Examples 1 to 8 and the polishing speed is low in the case of using the polishing compositions of Comparative Examples 7 to 8.

### Example 5

Non-modified colloidal silica (average primary particle size: 31 nm, average secondary particle size: 62 nm, average degree of association: 2.0) as abrasive grains was added to water so as to be at a concentration of 0.5% by mass with respect to 100% by mass of the entire mass of the polishing composition. Furthermore, etidronic acid (HEDP) and oleic acid diethanolamide were added thereto so as to be at a concentration of 0.75 g/L and a concentration of 100 ppm by mass, respectively. Thereafter, the mixture was stirred and mixed at room temperature (25° C.) for 30 minutes, thereby preparing a polishing composition. The pH of the polishing composition obtained was 2.5.

### Examples 6 and 7 and Comparative Example 9

Each polishing composition was prepared in the same manner as in Example 5 except that the amount of the pH adjusting agent and the kind of the scratch decreasing agent were changed as presented in the following Table 2.

### [Evaluation 2]

A 300 mm TEOS substrate (manufactured by Advantech Co., Ltd.) was prepared as an object to be polished. The TEOS substrate was polished under the same polishing conditions as in the Evaluation 1 using the respective polishing compositions of Examples 5 to 7 and Comparative Example 9 obtained above. Thereafter, the number of scratches and the polishing rate were evaluated in the same manner as in the Evaluation 1. The results are presented in the following Table 2.

TABLE 2

| | Abrasive | | | | | | | | | | TEOS |
|---|---|---|---|---|---|---|---|---|---|---|---|
| | grain | pH adjusting | | | | Scratch decreasing agent | | | | TEOS film | film |
| | Content | agent | | pH buffer agent | | | Content | | Polishing | Number of | Polishing |
| | (% by | | Content | | Content | | (ppm by | | composition | scratches | rate |
| | mass) | Kind | (g/L) | Kind | (g/L) | Kind | mass) | Log P | pH | (pieces) | (Å/min) |
| Example 5 | 0.5 | HEDP | 0.75 | — | — | Oleic acid diethanolamide | 100 | 6.68 | 2.5 | 24 | 224 |
| Example 6 | 0.5 | HEDP | 0.75 | — | — | Dimethyllaurylamine oxide | 100 | 3.09 | 2.5 | 21 | 232 |
| Example 7 | 0.5 | HEDP | 0.66 | — | — | Sorbitan monocaprylate | 100 | 1.33 | 2.5 | 25 | 215 |
| Comparative | 0.5 | HEDP | 0.66 | — | — | Ethanol | 100 | −0.18 | 2.5 | 54 | 204 |
| Example 9 | | | | | | | | | | | |

As apparent from Table 2 above, it has been found that the object to be polished having a TEOS film can be polished at a high polishing speed and scratches on the surface of the object to be polished having a TEOS film can be sufficiently decreased in the case of using the polishing compositions of Examples 5 to 7 containing a scratch decreasing agent having a Log P of 1.0 or more as compared to the polishing composition of Comparative Example 9. On the other hand, it has been found that a decrease in scratches on the surface of the object to be polished having a TEOS film is insufficient and the polishing speed is also low in the case of using the polishing composition of Comparative Example 9.

This application is based upon the Japanese Patent Application No. 2018-165032 filed on Sep. 4, 2018 and the Japanese Patent Application No. 2019-10484 filed on Jan. 24, 2019, the entire contents of which are incorporated herein by reference.

What is claimed is:

1. A polishing composition to be used to polish an object to be polished having a silicon oxide film, the polishing composition comprising an abrasive grain, a compound having a logarithmic value (Log P) of partition coefficient of 1.0 or more, and a dispersing medium, wherein
a pH of the polishing composition is less than 7.0.

2. The polishing composition according to claim 1, wherein a logarithmic value (Log P) of a partition coefficient of the compound is 7.0 or less.

3. The polishing composition according to claim 1, wherein the compound is a surfactant.

4. The polishing composition according to claim 1, wherein the polishing composition does not substantially comprise an oxidizing agent.

5. The polishing composition according to claim 1, wherein the compound does not have a sulfur atom.

6. The polishing composition according to claim 1, wherein the abrasive grain is non-modified silica.

7. The polishing composition according to claim 6, wherein the pH is 1.5 or more and 3.5 or less.

8. The polishing composition according to claim 1, wherein the abrasive grain is cation-modified silica.

9. The polishing composition according to claim 8, wherein the pH is 3.5 or more and 5.5 or less.

10. A method of producing a polishing composition which is used to polish an object to be polished having a silicon oxide film and has a pH of less than 7.0, the method comprising
mixing an abrasive grain, a compound having a logarithmic value (Log P) of partition coefficient of 1.0 or more, and a dispersing medium.

11. A polishing method comprising:
preparing an object to be polished having a silicon oxide film; and
polishing a surface of the object to be polished using the polishing composition according to claim 1.

12. A method of manufacturing a semiconductor substrate, the method comprising polishing a semiconductor substrate having a silicon oxide film by the polishing method according to claim 11.

13. A polishing system comprising an object to be polished having a silicon oxide film, a polishing pad, and a polishing composition, wherein
the polishing composition contains an abrasive grain, a compound having a logarithmic value (Log P) of partition coefficient of 1.0 or more, and a dispersing medium and has a pH of less than 7.0, and
a surface of the object to be polished is brought into contact with the polishing pad and the polishing composition.
